(19) United States
(12) Patent Application Publication
(10) Pub. No.: US 2025/0225207 A1
(43) Pub. Date: Jul. 10, 2025

(54) Cross-File Question And Answer Knowledge Extraction Method And System, And Electronic Device

(71) Applicant: Hangzhou Dianzi University, Hangzhou (CN)

(72) Inventors: Yuxia CHENG, Hangzhou (CN); Liaoman XU, Hangzhou (CN); Zhengbin ZHOU, Hangzhou (CN); Tianhao CAI, Hangzhou (CN); Jin FAN, Hangzhou (CN)

(21) Appl. No.: 18/432,008

(22) Filed: Feb. 4, 2024

(30) Foreign Application Priority Data
Jan. 4, 2024 (CN) 2024100164630

(51) Int. Cl. G06F 18/2413; G06N 5/02

(52) U.S. Cl. CPC G06F 18/24147; G06N 5/02

(57) ABSTRACT

The present disclosure provides a cross-file question and answer knowledge extraction method and system, and an electronic device. The method includes: obtaining a user question; converting the user question into a user question embedding vector by using an embedding function; determining the user question embedding vector and a first similarity vector of a root node of a file embedding vector tree of each professional knowledge file; determining a plurality of similar vector trees by using a K-nearest neighbor algorithm based on first similarity vectors of all root nodes; determining a candidate node set by using the K-nearest neighbor algorithm based on all the similar vector trees; determining an optimally-matched node set based on the candidate node set; and determining, based on the optimally-matched node set, file knowledge content corresponding to the user question. The present disclosure improves accuracy of extracting the cross-file question and answer knowledge.

### CROSS REFERENCE TO RELATED APPLICATION

This patent application claims the benefit and priority of Chinese Patent Application No. 2024100164630, filed with the China National Intellectual Property Administration on Jan. 4, 2024, the disclosure of which is incorporated by reference herein in its entirety as part of the present application.

### TECHNICAL FIELD

The present disclosure relates to the field of cross-file question and answer knowledge extraction, and in particular, to a cross-file question and answer knowledge extraction method and system, and an electronic device.

### BACKGROUND

In a specific field (such as medicine, laws, or scientific research), a large amount of professional knowledge is written and stored in a plurality of files. Semantically, these files may be highly similar as they all focus on a specific discipline or topic. In this case, it is often difficult to effectively distinguish and extract knowledge from these files by using traditional text mining and knowledge extraction technologies, such as keyword search and semantic search.

The traditional technologies mainly rely on a text vector (such as a word embedding or a sentence embedding) to represent and understand text content. However, for domain-specific text with highly-similar content, this method may not accurately distinguish and match a semantic relationship between a user question and file content, as a large number of semantically similar text vectors are gathered together in vector space.

The traditional technologies often have no sufficient capabilities to process questions of different granularities. For example, for a question about an overall structure (such as “what is a process of cell division?”), and a question about specific details (such as “what is a first stage of the cell division?”), the traditional technologies may not be able to distinguish types of knowledge required for the questions (structural knowledge or paragraph detail knowledge), thus failing to provide accurate and comprehensive answers.

### SUMMARY

The present disclosure is intended to provide a cross-file question and answer knowledge extraction method and system, and an electronic device to improve accuracy of extracting cross-file question and answer knowledge.

To achieve the above objectives, the present disclosure provides the following scheme: A cross-file question and answer knowledge extraction method includes obtaining a user question; converting the user question into a user question embedding vector by using an embedding function; determining the user question embedding vector and a first similarity vector of a root node of a file embedding vector tree of each professional knowledge file, where the file embedding vector tree includes the root node, a leaf node, and a non-root and non-leaf node; the root node includes a main title of the file, a main title embedding vector, an average embedding vector of chapter title embedding vectors, a file abstract, and an abstract embedding vector; the first similarity vector is a product of a vector corresponding to a maximum inner product value of each root node and the user question embedding vector; the maximum inner product value is a maximum value among an inner product of the user question embedding vector and each of the main title embedding vector, the average embedding vector, and the abstract embedding vector; the vector corresponding to the maximum inner product value is the main title embedding vector, the average embedding vector, or the abstract embedding vector; the leaf node includes paragraph text and a paragraph text embedding vector; the non-root and non-leaf node includes a chapter title, a chapter title embedding vector, an average embedding vector of subtitle or paragraph embedding vectors, a chapter abstract, and a chapter abstract embedding vector; determining a plurality of similar vector trees by using a K-nearest neighbor algorithm based on first similarity vectors of all root nodes; determining a candidate node set by using the K-nearest neighbor algorithm based on all the similar vector trees, where the candidate node set includes a candidate node subset for cross-file structural knowledge, a candidate node subset for cross-file paragraph knowledge, a candidate node subset for single-file structural knowledge, and a candidate node subset for single-file paragraph knowledge; determining an optimally-matched node set based on the candidate node set, where the optimally-matched node set is a subset corresponding to a maximum element sum in the candidate node set; the maximum element sum is a maximum value of a first element sum, a second element sum, a third element sum, and a fourth element sum; the first element sum is an element sum of a first average similarity vector of the candidate node subset for the cross-file structural question and answer knowledge; the first average similarity vector is an average value of similarity vectors of all nodes in the candidate node subset for the cross-file structural question and answer knowledge; the second element sum is an element sum of a second average similarity vector of the candidate node subset for the cross-file paragraph question and answer knowledge; the second average similarity vector is an average value of similarity vectors of all nodes in the candidate node subset for the cross-file paragraph question and answer knowledge; the third element sum is an element sum of a third average similarity vector of the candidate node subset for the single-file structural question and answer knowledge; the third average similarity vector is an average value of similarity vectors of all nodes in the candidate node subset for the single-file structural question and answer knowledge; the fourth element sum is an element sum of a fourth average similarity vector of the candidate node subset for the single-file paragraph question and answer knowledge; and the fourth average similarity vector is an average value of similarity vectors of all nodes in the candidate node subset for the single-file paragraph question and answer knowledge; and determining, based on the optimally-matched node set, file knowledge content corresponding to the user question, where the file knowledge content includes the main title, the chapter title, the chapter abstract, a paragraph body of the file or combinations thereof.

Optionally, the cross-file question and answer knowledge extraction method further includes constructing the file embedding vector tree.

Optionally, the constructing the file embedding vector tree specifically includes: obtaining a plurality of professional knowledge files; preprocessing the professional knowledge files to determine file information, where the file information includes the main title, the chapter title, a paragraph body under each chapter, the chapter abstract, and the file abstract; and constructing the file embedding vector tree based on the file information.

Optionally, the preprocessing the professional knowledge files to determine file information specifically includes: extracting key information of each of the professional knowledge files, where the key information includes the main title, the chapter title, and the paragraph body under each chapter; generating the chapter abstract for each chapter of each of the professional knowledge files by using an abstract generation function, where the abstract generation function is a deep learning-based abstract generation model or a rule-based abstract generation algorithm; and generating the file abstract for each of the professional knowledge files based on a plurality of chapter abstracts of the professional knowledge file.

Optionally, the determining the user question embedding vector and a first similarity vector of a root node of a file embedding vector tree of each professional knowledge file specifically includes: calculating the inner product of the user question embedding vector and each of the main title embedding vector, the average embedding vector, and the abstract embedding vector of the file embedding vector tree of each professional knowledge file to obtain a first inner product, a second inner product, and a third inner product; comparing the first inner product, the second inner product, and the third inner product to determine the maximum inner product value and the vector corresponding to the maximum inner product value; and determining a first similarity vector for each root node based on the vector corresponding to the maximum inner product value and the user question embedding vector.

Optionally, the determining a plurality of similar vector trees by using a K-nearest neighbor algorithm based on first similarity vectors of all root nodes specifically includes: calculating a first similarity element sum of each root node, where the first similarity element sum is an element sum of the first similarity vector of the root node; sorting all first similarity element sums in descending order, and selecting a first preset quantity of top first similarity element sums; determining an initial candidate node set by using root nodes corresponding to the first preset quantity of top first similarity element sums as candidate nodes; and selecting a benchmark similarity vector from the initial candidate node set, and determining a second preset quantity of similar vector trees by using the K-nearest neighbor algorithm, where the benchmark similarity vector is a first similarity vector corresponding to a maximum first similarity element sum, and the second preset quantity is less than the first preset quantity.

Optionally, the determining a candidate node set by using the K-nearest neighbor algorithm based on all the similar vector trees specifically includes: constructing a virtual root node based on a second preset quantity of similar vector trees; calculating a second similarity vector between the user question embedding vector and a non-root and non-leaf node of each file embedding vector tree; calculating a second similarity element sum of each non-root and non-leaf node, where the second similarity element sum is an element sum of a second similarity vector of the non-root and non-leaf node; sorting all second similarity element sums in descending order, and selecting a third preset quantity of top second similarity element sums; determining the candidate node subset for the cross-file structural question and answer knowledge by using the K-nearest neighbor algorithm based on the third preset quantity of top second similarity element sums; calculating a third similarity vector between the user question embedding vector and a leaf node of each file embedding vector tree; calculating a third similarity element sum of each leaf node, where the third similarity element sum is an element sum of a third similarity vector of the leaf node; sorting all third similarity element sums in descending order, and selecting a fourth preset quantity of top third similarity element sums; determining the candidate node subset for the cross-file paragraph question and answer knowledge by using the K-nearest neighbor algorithm based on the fourth preset quantity of top third similarity element sums; determining all second similarity element sums in a first target file embedding vector tree, where the first target file embedding vector tree is a file embedding vector tree of a non-root and non-leaf node corresponding to a maximum second similarity element sum; sorting all the second similarity element sums in the first target file embedding vector tree in descending order, and selecting a fifth preset quantity of top second similarity element sums in the first target file embedding vector tree; determining the candidate node subset for the single-file structural question and answer knowledge based on the fifth preset quantity of top second similarity element sums; determining all third similarity element sums in a second target file embedding vector tree, where the second target file embedding vector tree is a file embedding vector tree of a leaf node corresponding to a maximum third similarity element sum; sorting all the third similarity element sums in the second target file embedding vector tree in descending order, and selecting a sixth preset quantity of top third similarity element sums in the second target file embedding vector tree; and determining the candidate node subset for the single-file paragraph question and answer knowledge based on the sixth preset quantity of top third similarity element sums.

A cross-file question and answer knowledge extraction system includes: a question obtaining module configured to obtain a user question; a conversion module configured to convert the user question into a user question embedding vector by using an embedding function; a similarity vector determining module configured to determine the user question embedding vector and a first similarity vector of a root node of a file embedding vector tree of each professional knowledge file, where the file embedding vector tree includes the root node, a leaf node, and a non-root and non-leaf node; the root node includes a main title of the file, a main title embedding vector, an average embedding vector of chapter title embedding vectors, a file abstract, and an abstract embedding vector; the first similarity vector is a product of a vector corresponding to a maximum inner product value of each root node and the user question embedding vector; the maximum inner product value is a maximum value among an inner product of the user question embedding vector and each of the main title embedding vector, the average embedding vector, and the abstract embedding vector; the vector corresponding to the maximum inner product value is the main title embedding vector, the average embedding vector, or the abstract embedding vector; the leaf node includes paragraph text and a paragraph text embedding vector; the non-root and non-leaf node includes a chapter title, a chapter title embedding vector, an average embedding vector of subtitle or paragraph embedding vectors, a chapter abstract, and a chapter abstract embedding vector; a similar vector tree determining module configured to determine a plurality of similar vector trees by using a K-nearest neighbor algorithm based on first similarity vectors of all root nodes; a candidate node determining module configured to determine a candidate node set by using the K-nearest neighbor algorithm based on all the similar vector trees, where the candidate node set includes a candidate node subset for cross-file structural knowledge, a candidate node subset for cross-file paragraph knowledge, a candidate node subset for single-file structural knowledge, and a candidate node subset for single-file paragraph knowledge; an optimally-matched node determining module configured to determine an optimally-matched node set based on the candidate node set, where the optimally-matched node set is a subset corresponding to a maximum element sum in the candidate node set; the maximum element sum is a maximum value of a first element sum, a second element sum, a third element sum, and a fourth element sum; the first element sum is an element sum of a first average similarity vector of the candidate node subset for the cross-file structural question and answer knowledge; the first average similarity vector is an average value of similarity vectors of all nodes in the candidate node subset for the cross-file structural question and answer knowledge; the second element sum is an element sum of a second average similarity vector of the candidate node subset for the cross-file paragraph question and answer knowledge; the second average similarity vector is an average value of similarity vectors of all nodes in the candidate node subset for the cross-file paragraph question and answer knowledge; the third element sum is an element sum of a third average similarity vector of the candidate node subset for the single-file structural question and answer knowledge; the third average similarity vector is an average value of similarity vectors of all nodes in the candidate node subset for the single-file structural question and answer knowledge; the fourth element sum is an element sum of a fourth average similarity vector of the candidate node subset for the single-file paragraph question and answer knowledge; and the fourth average similarity vector is an average value of similarity vectors of all nodes in the candidate node subset for the single-file paragraph question and answer knowledge; and a knowledge extraction module configured to determine, based on the optimally-matched node set, file knowledge content corresponding to the user question, where the file knowledge content includes the main title, the chapter title, the chapter abstract, a paragraph body of the file or combinations thereof.

An electronic device includes a memory and a processor, where the memory is configured to store a computer program, and the processor runs the computer program to enable the electronic device to execute the above cross-file question and answer knowledge extraction method.

Optionally, the memory is a readable storage medium.

According to specific embodiments provided in the present disclosure, the present disclosure has following technical effects: According to a cross-file question and answer knowledge extraction method and system, and an electronic device that are provided in the present disclosure, a user question is obtained; the user question is converted into a user question embedding vector by using an embedding function; the user question embedding vector and a first similarity vector of a root node of a file embedding vector tree of each professional knowledge file is determined; a plurality of similar vector trees are determined by using a K-nearest neighbor algorithm based on first similarity vectors of all root nodes; a candidate node set is determined by using the K-nearest neighbor algorithm based on all the similar vector trees; an optimally-matched node set is determined based on the candidate node set; and file knowledge content corresponding to the user question is determined based on the optimally-matched node set. The present disclosure improves accuracy of extracting cross-file question and answer knowledge.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other accompanying drawings can be derived from these accompanying drawings by those of ordinary skill in the art without creative efforts.

FIG. 1 is a flowchart of a cross-file question and answer knowledge extraction method according to the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

The present disclosure is intended to provide a cross-file question and answer knowledge extraction method and system, and an electronic device to improve accuracy of extracting cross-file question and answer knowledge.

In order to resolve the problems in the prior art, a cross-file question and answer knowledge extraction method is developed. This method can effectively distinguish and extract highly similar content by constructing a file text embedding vector tree and adaptively calculating a similarity between a question text vector and a node vector in each layer of the vector tree. In addition, four different types of knowledge type extraction methods are designed, which makes it possible to adaptively extract structural knowledge and paragraph detail knowledge based on a question granularity. This not only improves accuracy and efficiency of knowledge extraction, but also makes the knowledge extraction more adaptable and comprehensive.

In order to make the above objectives, features, and advantages of the present disclosure clearer and more comprehensible, the present disclosure will be further described in detail below in combination with the accompanying drawings and specific implementations.

### Embodiment 1

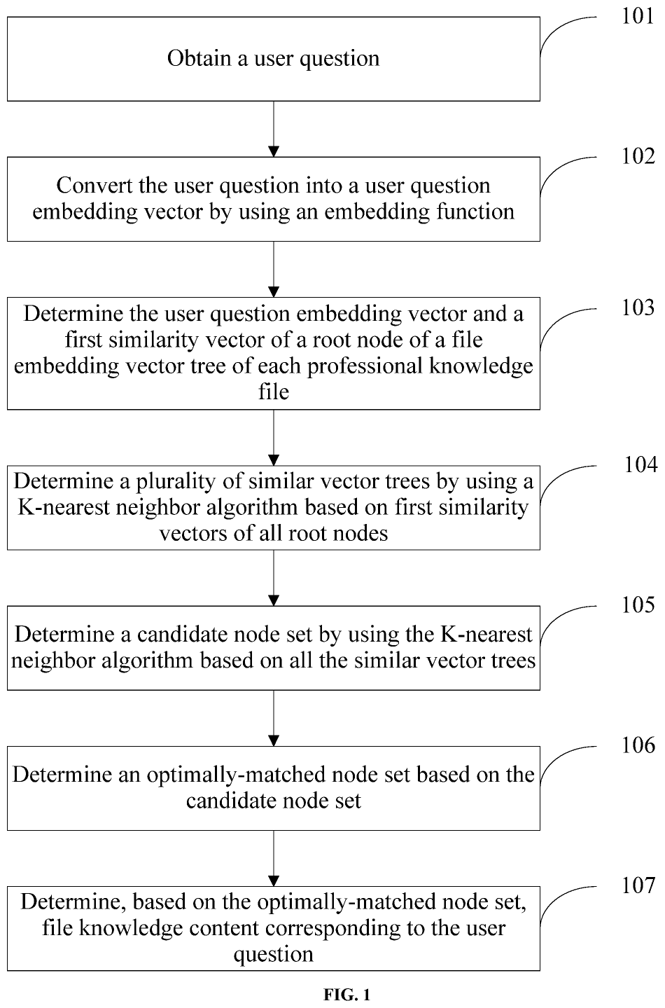

As shown in FIG. 1, a cross-file question and answer knowledge extraction method provided in the present disclosure includes the following steps.

Step 101: Obtain a user question.

Step 102: Convert the user question into a user question embedding vector by using an embedding function.

Step 103: Determine the user question embedding vector and a first similarity vector of a root node of a file embedding vector tree of each professional knowledge file, where the file embedding vector tree includes the root node, a leaf node, and a non-root and non-leaf node; the root node includes a main title of the file, a main title embedding vector, an average embedding vector of chapter title embedding vectors, a file abstract, and an abstract embedding vector; the first similarity vector is a product of a vector corresponding to a maximum inner product value of each root node and the user question embedding vector; the maximum inner product value is a maximum value among an inner product of the user question embedding vector and each of the main title embedding vector, the average embedding vector, and the abstract embedding vector; the vector corresponding to the maximum inner product value is the main title embedding vector, the average embedding vector, or the abstract embedding vector; the leaf node includes paragraph text and a paragraph text embedding vector; the non-root and non-leaf node includes a chapter title, a chapter title embedding vector, an average embedding vector of subtitle or paragraph embedding vectors, a chapter abstract, and a chapter abstract embedding vector.

As an optional implementation, the cross-file question and answer knowledge extraction method in the present disclosure further includes: constructing the file embedding vector tree, which specifically includes: obtaining a plurality of professional knowledge files; and

preprocessing the professional knowledge files to determine file information, where the file information includes the main title, the chapter title, a paragraph body under each chapter, the chapter abstract, and the file abstract.

As an optional implementation, the preprocessing the professional knowledge files to determining file information specifically includes: Key information of each of the professional knowledge files is extracted. The key information includes the main title, the chapter title, and the paragraph body under each chapter. In a practical application, key information of each file needs to be extracted. It is assumed that there are a series of files, namely F=f₁, f₂, . . . , fₙ. Each file fᵢ can be further decomposed into a main title Tᵢ, a chapter title Cᵢ={cᵢ₁, cᵢ₂, . . . , cᵢₘ}, and a paragraph Pᵢ={pᵢ₁, pᵢ₂, . . . , pᵢₖ} under each chapter. This step is intended to extract the Tᵢ, the Cᵢ, and the Pᵢ of each file and clearly record a hierarchical relationship between each title and a paragraph.

The chapter abstract is generated for each chapter of each of the professional knowledge files by using an abstract generation function. The abstract generation function is a deep learning-based abstract generation model or a rule-based abstract generation algorithm. In a practical application, an abstract is generated for each chapter. It is assumed that a function S( ) is the abstract generation function. This function is applied to each chapter cᵢⱼ to generate an abstract sᵢⱼ=S(cᵢⱼ). The abstract generation function S( ) may be the deep learning-based abstract generation model or the rule-based abstract generation algorithm.

The file abstract is generated for each of the professional knowledge files based on a plurality of chapter abstracts of the professional knowledge file. In a practical application, after the chapter abstract is completed, an abstract of the entire file is generated based on the abstract of each chapter. The abstract of the entire file provides an overall perspective to understand content of the entire file. The abstract of the entire file (file abstract) can be generated by fusing each chapter abstract sᵢⱼ, in other words, Sᵢ=Uⱼ₌₁^{m}sᵢⱼ.

The file embedding vector tree is constructed based on the file information.

After the preprocessing is completed, a stage of constructing the file embedding vector tree is executed. It is assumed that there is an embedding function E( ) that can convert text into an embedding vector. For each file fᵢ, a file embedding vector tree Vᵢ is constructed. In the tree, a root node Rᵢ includes a main title Tᵢ of the file, a main title embedding vector E(Tᵢ), an average value

$$\frac{1}{m} {\sum }_{j = 1}^{m} E ( {c}_{ij} )$$

of embedding vectors E(cᵢⱼ) of all subnodes (chapter titles), a file abstract Sᵢ, and an abstract embedding vector E(Sᵢ).

Each non-root and non-leaf node, namely, each title node Nᵢⱼ, contains a chapter title cᵢⱼ, a chapter tile embedding vector (cᵢⱼ), an average value

$$\frac{1}{k} {\sum }_{k = 1}^{k} E ( {c}_{ik}^{child} \vert {p}_{ik}^{child} )$$

of embedding vectors E(cᵢₖ^{child}|pᵢₖ^{child}) of all subnodes (subtitles or paragraphs) of the node, and a chapter abstract sᵢⱼ and a chapter abstract embedding vector sᵢⱼ that are contained in the node.

Each leaf node Pᵢⱼ contains paragraph text Pᵢⱼ and an embedding vector E(Pᵢⱼ) of the text.

In this way, the detailed vector tree Vᵢ is constructed for each file fᵢ for subsequent text analysis and processing.

As an optional implementation, the step 103 specifically includes:
calculating the inner product of the user question embedding vector and each of the main title embedding vector, the average embedding vector, and the abstract embedding vector of the file embedding vector tree of each professional knowledge file to obtain a first inner product, a second inner product, and a third inner product; comparing the first inner product, the second inner product, and the third inner product to determine the maximum inner product value and the vector corresponding to the maximum inner product value; and determining a first similarity vector for each root node based on the vector corresponding to the maximum inner product value and the user question embedding vector.

In a practical application, first, it is assumed that the user question is Q. The user question can be converted into the user question embedding vector E(Q) by using the embedding function E( ). Then, an inner product of the user question embedding vector E(Q) and each of the three vectors contained in the root node Rᵢ of each vector tree (the main title vector E(Tᵢ), the average embedding vector

$$\frac{1}{m} {\sum }_{j = 1}^{m} E ( {c}_{ij} )$$

of the subnodes, and the file abstract embedding vector E(Sᵢ)) is calculated. It is assumed that a vector inner product function is I( ) Three inner product values can be obtained: I_{Ti}=I(E(Q), E(Tᵢ)), I_{Ci}=I(E(Q),

$$\frac{1}{m} {\sum }_{j = 1}^{m} E ( {c}_{ij} ) ) ,$$

and I_{Si}=I(E(Q), E(Sᵢ)).

Because the main title of the file may be inaccurate or a semantic correlation of the user question may be reflected in the abstract, or even in more subtle semantics, it is necessary to compare the three inner product values, and select a maximum inner product value and a corresponding vector. In this way, the maximum inner product value Iₘₐₓⁱ=Max(I_{Ti}, I_{Ci}, I_{Si})) can be obtained. It is assumed that Vₘₐₓⁱ is the vector corresponding to the maximum inner product value, which is calculated according to a following formula:

$${V}_{max}^{i} = {arg max}_{E} \{ {I}_{Ti} , {I}_{Ci} , {I}_{Si} \}$$

Finally, a first similarity vector Simᵢ=Vₘₐₓⁱ·E(Q) is obtained by performing element multiplication on the vector Vₘₐₓⁱ corresponding to the maximum inner product value and the user question embedding vector E(Q). The similarity vector will be used for subsequent sorting and selection operations to find file content that best meets a user demand.

Step 104: Determine a plurality of similar vector trees by using a K-nearest neighbor algorithm based on first similarity vectors of all root nodes.

As an optional implementation, the step 104 specifically includes the following sub-steps:

A first similarity element sum of each root node is calculated. The first similarity element sum is an element sum of the first similarity vector of the root node. In a practical application, it is required to calculate a vector sum (element sum) of the first similarity vector Simᵢ of each root node, and add elements in each vector Sim; one by one. Assuming that the vector Simᵢ has elements se₁, se₂, . . . , and se_{z}, a vector sum Sumᵢ=Σ_{d=1}^{z}se_{d} is obtained.

All first similarity element sums are sorted in descending order, and a first preset quantity of top first similarity element sums are selected.

An initial candidate node set is determined by selecting root nodes corresponding to the first preset quantity of top first similarity element sums as candidate nodes.

In a practical application, each Sumᵢ is sorted in descending order, and TopL (the first preset quantity) root nodes are selected as candidate nodes that are most similar to the user question embedding vector. An initial candidate node set CR_{L}={R₁, R₂ . . . , R_{L}}; obtained.

A benchmark similarity vector is selected from the initial candidate node set, and a second preset quantity of similar vector trees are determined by using the K-nearest neighbor algorithm. The benchmark similarity vector is a first similarity vector corresponding to a maximum first similarity element sum, and the second preset quantity is less than the first preset quantity.

In a practical application, in order to extract a correlation of knowledge content in a question and answer scenario, it is required to find a vector with a closest relationship from these candidate vectors (the initial candidate node set). Therefore, a 1^{st} first similarity vector Sim_{R1} is selected as a benchmark, and then the K-nearest neighbor method is applied. The initial candidate node set CR_{L} is searched for TopK−1 (K is the second preset quantity) vectors that are closest to the 1^{st} first similarity vector Sim_{R1}, and a first similarity vector set SC_{K}={Sim_{R}_{₁}, Sim_{R}_{₂}, Sim_{R}_{ₖ}} is obtained, where k=2, . . . , K. In this way, TopK similar vector trees {R₁, R₂, . . . , R_{K}} are obtained.

In a practical application, a value of the TopL may be set to 50, and a value of the TopK may be set to 10. These values may be adjusted based on a knowledge difference in a specific-domain file, and optimal parameters need to be determined through an experiment.

Step 105: Determine a candidate node set by using the K-nearest neighbor algorithm based on all the similar vector trees, where the candidate node set includes a candidate node subset for cross-file structural knowledge, a candidate node subset for cross-file paragraph knowledge, a candidate node subset for single-file structural knowledge, and a candidate node subset for single-file paragraph knowledge.

As an optional implementation, the step 105 specifically includes following substeps:

A virtual root node is constructed based on a second preset quantity of similar vector trees. In a practical application, a virtual root node VR is constructed, and its subnode is the root node of the similar vector tree in the step 104.

A second similarity vector between the user question embedding vector and a non-root and non-leaf node of each file embedding vector tree is calculated.

In a practical application, a second similarity vector between each non-root and non-leaf node Nᵢⱼ and the user question embedding vector E(Q) is calculated as follows:

Simᵢⱼ^{N}=Vₘₐₓ^{N}^{ᵢⱼ}·E(Q).

A second similarity element sum of each non-root and non-leaf node is calculated. The second similarity element sum is an element sum of a second similarity vector of the non-root and non-leaf node.

In a practical application, a vector sum Sumᵢⱼ=Σ_{d=1}^{z}se_{d}^{Sim}^{ᵢⱼ}^{^{N}} of the second similarity vector Simᵢⱼ^{N} is calculated.

All second similarity element sums are sorted in descending order, and a third preset quantity of top second similarity element sums are selected.

In a practical application, all vector sums are sorted in descending order, and TopL1 (the third preset quantity) similarity vectors {Simᵢ₁^{N}, Simᵢ₂^{N}, . . . , Sim_{iTopL1}^{N}} with a maximum vector sum are selected.

The candidate node subset for the cross-file structural question and answer knowledge is determined by using the K-nearest neighbor algorithm based on the third preset quantity of top second similarity element sums.

In a practical application, a 1^{st} similarity vector Simᵢⱼ¹ is selected from the TopL1 similarity vectors as a benchmark. A K-nearest neighbor method is used to search for TopK1−1 (K1 is a seventh preset quantity) similarity vectors that are closest to the Simᵢⱼ¹, to obtain a candidate node subset C1={Nᵢ₁, Nᵢ₂, . . . , N_{iTopK1}} for the cross-file structural question and answer knowledge.

A third similarity vector between the user question embedding vector and a leaf node of each file embedding vector tree is calculated.

In a practical application, starting from the virtual root node VR constructed in the step 105, a similarity vector between each leaf node Pij and the user question embedding vector E(Q) is calculated as follows:

Simᵢⱼ^{P}=Vₘₐₓ^{P}^{ᵢⱼ}·E(Q)

Vₘₐₓ^{P}^{ᵢⱼ} represents a vector with a largest dot product value after a dot product operation is performed on the three vectors contained in the leaf node and the vector E(Q).

A third similarity element sum of each leaf node is calculated. The third similarity element sum is an element sum of a third similarity vector of the leaf node.

In a practical application, a vector sum Sumᵢⱼ^{P}=Σ_{d=1}^{z}se_{d}^{Sim}^{ᵢⱼ}^{^{P}} of all third similarity vectors Simᵢⱼ^{P} is calculated.

All third similarity element sums are sorted in descending order, and a fourth preset quantity of top third similarity element sums are selected.

In a practical application, all vector sums Sumᵢⱼ^{P} are sorted in descending order, and TopL2 (the fourth preset quantity) third similarity vectors {Simᵢ₁^{P}, Simᵢ₂^{P}, . . . , Sim_{iTopL2}^{P}} with a maximum vector sum are selected.

The candidate node subset for the cross-file paragraph question and answer knowledge is determined by using the K-nearest neighbor algorithm based on the fourth preset quantity of top third similarity element sums.

In a practical application, a 1^{st} third similarity vector Simᵢ₁^{P} is selected from the TopL2 third similarity vectors as a benchmark. The K-nearest neighbor method is used to search for TopK2−1 (K2 is an eighth preset quantity) third similarity vectors that are closest to the Simᵢ₁^{P}, to obtain a candidate node subset C2={Pᵢ₁, Pᵢ₂, . . . , P_{iTopK2}} for the cross-file paragraph question and answer knowledge.

All second similarity element sums in a first target file embedding vector tree are determined. The first target file embedding vector tree is a file embedding vector tree of a non-root and non-leaf node corresponding to a maximum second similarity element sum. In a practical application, a similarity vector Simᵢ₁^{N} corresponding to the maximum second similarity element sum of the non-root and non-leaf node is selected. The file embedding vector tree of the non-root and non-leaf node is selected, and a vector sum Sumᵢⱼ^{N′}=Σ_{d=1}^{z}se_{d}^{Sim}^{ᵢⱼ}^{^{N′}} of each non-root and non-leaf node in the vector tree is calculated and sorted in descending order.

All the second similarity element sums in the first target file embedding vector tree are sorted in descending order, and a fifth preset quantity of top second similarity element sums in the first target file embedding vector tree are selected.

The candidate node subset for the single-file structural question and answer knowledge is determined based on the fifth preset quantity of top second similarity element sums.

TopK3 (fifth preset quantity) non-root and non-leaf nodes with a maximum vector sum are selected from the non-root and non-leaf nodes in the selected vector tree as a candidate node subset C3={Nᵢ₁′, Nᵢ₂′, . . . , N_{iTopK3}′} for single-file structural knowledge extraction.

All third similarity element sums in a second target file embedding vector tree are determined. The second target file embedding vector tree is a file embedding vector tree of a leaf node corresponding to a maximum third similarity element sum. In a practical application, a similarity vector (third similarity vector) Simᵢ₁^{P} corresponding to a maximum vector sum of the leaf node is selected.

All the third similarity element sums in the second target file embedding vector tree are sorted in descending order, and a sixth preset quantity of top third similarity element sums in the second target file embedding vector tree are selected.

The candidate node subset for the single-file paragraph question and answer knowledge is determined based on the sixth preset quantity of top third similarity element sums.

In a practical application, the vector tree of the leaf node (the second target file embedding vector tree) is selected, and a vector sum Sumᵢⱼ^{P′}=Σ_{d=1}^{z}se_{d}^{Sim}^{ᵢⱼ}^{P′} of each leaf node in the vector tree is calculated and sorted in descending order.

TopK4 (the sixth preset quantity) leaf nodes with a maximum vector sum are selected from the leaf nodes in the selected vector tree as a candidate node subset C4={Pᵢ₁′, Pᵢ₂′, . . . , P_{iTopK4}′} for single-file paragraph knowledge extraction.

Step 106: Determine an optimally-matched node set based on the candidate node set, where the optimally-matched node set is a subset corresponding to a maximum element sum in the candidate node set; the maximum element sum is a maximum value of a first element sum, a second element sum, a third element sum, and a fourth element sum; the first element sum is an element sum of a first average similarity vector of the candidate node subset for the cross-file structural question and answer knowledge; the first average similarity vector is an average value of similarity vectors of all nodes in the candidate node subset for the cross-file structural question and answer knowledge; the second element sum is an element sum of a second average similarity vector of the candidate node subset for the cross-file paragraph question and answer knowledge; the second average similarity vector is an average value of similarity vectors of all nodes in the candidate node subset for the cross-file paragraph question and answer knowledge; the third element sum is an element sum of a third average similarity vector of the candidate node subset for the single-file structural question and answer knowledge; the third average similarity vector is an average value of similarity vectors of all nodes in the candidate node subset of the single-file structural question and answer knowledge; the fourth element sum is an element sum of a fourth average similarity vector of the candidate node subset for the single-file paragraph question and answer knowledge; and the fourth average similarity vector is an average value of similarity vectors of all nodes in the candidate node subset for the single-file paragraph question and answer knowledge.

In a practical application, an average similarity vector is calculated. An average similarity vector of all nodes in each of sets C1, C2, C3, and C4 is calculated. In this way, a first average similarity vector, a second average similarity vector, a third average similarity vector, and a fourth average similarity vector are respectively generated for the sets C1, C2, C3, and C4.

Specifically, for a set Cᵢ (i=1, 2, 3, 4), its average similarity vector AvgSimᵢ can be calculated according to a following formula:

$${AvgSim}_{i} = \frac{1}{\vert Ci \vert} {\sum }_{{N}_{j} ∈ Ci} {Sim}_{j}^{N}$$

In the above formula, |Cᵢ| represents a quantity of nodes in the set Cᵢ, and Simⱼ represents a similarity vector of a node Nⱼ.

An average similarity vector sum is calculated. For the calculated average similarity vector, a vector sum is calculated. In this way, an average similarity vector sum AvgSumᵢ is generated for each set Cᵢ (i=1, 2, 3, 4). Specifically, the AvgSumᵢ can be calculated according to a following formula

$${AvgSum}_{i} = {\sum }_{d = 1}^{z} {se}_{d}^{{AvgSim}_{i}}$$

In the above formula, se_{d}^{AvgSim}^{ᵢ} represents a d^{th} element of the vector AvgSimᵢ.

A subset with a maximum average similarity vector sum is selected. Specifically, each AvgSumᵢ (i=1, 2, 3, 4) is compared, and a subset with a maximum vector sum, which is denoted as C_{best}, is selected as the optimally-matched node set.

Step 107: Determine, based on the optimally-matched node set, file knowledge content corresponding to the user question, where the file knowledge content includes the main title, the chapter title, the chapter abstract, a paragraph body of the file or combinations thereof.

In a practical application, extraction results of all nodes in the Chest include titles, abstracts, or paragraph text of these nodes.

(1) Accuracy is improved: Accuracy of matching a question and text information can be improved by constructing a file embedding vector tree and adaptively calculating a similarity between a question text vector and a node vector in each layer of the vector tree. The file embedding vector tree provides a hierarchical structure for the text information, and question-related information can be found more accurately by adaptively calculating a similarity between a user question embedding vector and the vector tree.

(2) Efficiency is improved: Through adaptive spatial partitioning, discrimination can be adaptively improved based on different distribution densities of question and content semantics, thereby quickly finding most relevant information in a large amount of information and improving search efficiency. A similarity between the user question embedding vector and the node vector in each layer of the vector tree is adaptively calculated, and a reasonable spatial partitioning strategy makes a search process more efficient.

(3) Adaptability is improved: Four different types of knowledge extraction methods are designed. In this way, based on different types of user questions, cross-file structural knowledge, cross-file paragraph knowledge, single-file structural knowledge, and single-file paragraph knowledge can be adaptively extracted, thereby improving adaptability and comprehensiveness of question answering. In other words, the four types of knowledge extraction methods can flexibly extract different types of knowledge based on characteristics of the question.

(4) Comprehensiveness: This method considers both cross-file knowledge extraction and extraction of structural and detailed knowledge, and can find a most comprehensive answer in a large amount of information. In other words, the four types of knowledge extraction methods can simultaneously consider the extraction of structural and detailed knowledge in a single file and different files.

In summary, the adaptive cross-file question and answer knowledge extraction method effectively improves accuracy, efficiency, adaptability, and comprehensiveness of a question and answer system by constructing the file text embedding vector tree, adaptively calculating the similarity between the user question embedding vector and the vector tree, and designing the four types of knowledge extraction methods.

### Embodiment 2

To execute the method corresponding to Embodiment 1 to achieve corresponding functions and technical effects, the following provides a cross-file question and answer knowledge extraction system, including: a question obtaining module configured to obtain a user question; a conversion module configured to convert the user question into a user question embedding vector by using an embedding function; a similarity vector determining module configured to determine the user question embedding vector and a first similarity vector of a root node of a file embedding vector tree of each professional knowledge file, where the file embedding vector tree includes the root node, a leaf node, and a non-root and non-leaf node; the root node includes a main title of the file, a main title embedding vector, an average embedding vector of chapter title embedding vectors, a file abstract, and an abstract embedding vector; the first similarity vector is a product of a vector corresponding to a maximum inner product value of each root node and the user question embedding vector; the maximum inner product value is a maximum value among an inner product of the user question embedding vector and each of the main title embedding vector, the average embedding vector, and the abstract embedding vector; the vector corresponding to the maximum inner product value is the main title embedding vector, the average embedding vector, or the abstract embedding vector; the leaf node includes paragraph text and a paragraph text embedding vector; the non-root and non-leaf node includes a chapter title, a chapter title embedding vector, an average embedding vector of subtitle or paragraph embedding vectors, a chapter abstract, and a chapter abstract embedding vector; a similar vector tree determining module configured to determine a plurality of similar vector trees by using a K-nearest neighbor algorithm based on first similarity vectors of all root nodes; a candidate node determining module configured to determine a candidate node set by using the K-nearest neighbor algorithm based on all the similar vector trees, where the candidate node set includes a candidate node subset for cross-file structural knowledge, a candidate node subset for cross-file paragraph knowledge, a candidate node subset for single-file structural knowledge, and a candidate node subset for single-file paragraph knowledge; an optimally-matched node determining module configured to determine an optimally-matched node set based on the candidate node set, where the optimally-matched node set is a subset corresponding to a maximum element sum in the candidate node set; the maximum element sum is a maximum value of a first element sum, a second element sum, a third element sum, and a fourth element sum; the first element sum is an element sum of a first average similarity vector of the candidate node subset for the cross-file structural question and answer knowledge; the first average similarity vector is an average value of similarity vectors of all nodes in the candidate node subset for the cross-file structural question and answer knowledge; the second element sum is an element sum of a second average similarity vector of the candidate node subset for the cross-file paragraph question and answer knowledge; the second average similarity vector is an average value of similarity vectors of all nodes in the candidate node subset for the cross-file paragraph question and answer knowledge; the third element sum is an element sum of a third average similarity vector of the candidate node subset for the single-file structural question and answer knowledge; the third average similarity vector is an average value of similarity vectors of all nodes in the candidate node subset for the single-file structural question and answer knowledge; the fourth element sum is an element sum of a fourth average similarity vector of the candidate node subset for the single-file paragraph question and answer knowledge; and the fourth average similarity vector is an average value of similarity vectors of all nodes in the candidate node subset for the single-file paragraph question and answer knowledge; and a knowledge extraction module configured to determine, based on the optimally-matched node set, file knowledge content corresponding to the user question, where the file knowledge content includes the main title, the chapter title, the chapter abstract, a paragraph body of the file or combinations thereof.

### Embodiment 3

The present disclosure provides an electronic device, including a memory and a processor. The memory is configured to store a computer program, and the processor runs the computer program to enable the electronic device to execute the cross-file question and answer knowledge extraction method in Embodiment 1.

As an optional implementation, the memory is a readable storage medium.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related content, references can be made to the description of the method.

Particular examples are used herein for illustration of principles and implementations of the present disclosure. The descriptions of the above embodiments are merely used for helping understanding of the method of the present disclosure and its core ideas. In addition, those of ordinary skill in the art can make various modifications in terms of particular implementations and the scope of application in accordance with the ideas of the present disclosure. In conclusion, the content of the description shall not be construed as limitations to the present disclosure.

What is claimed is:

1. A cross-file question and answer knowledge extraction method, comprising:
obtaining a user question;
converting the user question into a user question embedding vector by using an embedding function;
determining the user question embedding vector and a first similarity vector of a root node of a file embedding vector tree of each professional knowledge file, wherein the file embedding vector tree comprises the root node, a leaf node, and a non-root and non-leaf node; the root node comprises a main title of the file, a main title embedding vector, an average embedding vector of chapter title embedding vectors, a file abstract, and an abstract embedding vector; the first similarity vector is a product of a vector corresponding to a maximum inner product value of each root node and the user question embedding vector; the maximum inner product value is a maximum value among an inner product of the user question embedding vector and each of the main title embedding vector, the average embedding vector, and the abstract embedding vector; the vector corresponding to the maximum inner product value is the main title embedding vector, the average embedding vector, or the abstract embedding vector; the leaf node comprises paragraph text and a paragraph text embedding vector; the non-root and non-leaf node comprises a chapter title, a chapter title embedding vector, an average embedding vector of subtitle or paragraph embedding vectors, a chapter abstract, and a chapter abstract embedding vector;
determining a plurality of similar vector trees by using a K-nearest neighbor algorithm based on first similarity vectors of all root nodes;
determining a candidate node set by using the K-nearest neighbor algorithm based on all the similar vector trees, wherein the candidate node set comprises a candidate node subset for cross-file structural knowledge, a candidate node subset for cross-file paragraph knowledge, a candidate node subset for single-file structural knowledge, and a candidate node subset for single-file paragraph knowledge;
determining an optimally-matched node set based on the candidate node set, wherein the optimally-matched node set is a subset corresponding to a maximum element sum in the candidate node set; the maximum element sum is a maximum value of a first element sum, a second element sum, a third element sum, and a fourth element sum; the first element sum is an element sum of a first average similarity vector of the candidate node subset for the cross-file structural question and answer knowledge; the first average similarity vector is an average value of similarity vectors of all nodes in the candidate node subset for the cross-file structural question and answer knowledge; the second element sum is an element sum of a second average similarity vector of the candidate node subset for the cross-file paragraph question and answer knowledge; the second average similarity vector is an average value of similarity vectors of all nodes in the candidate node subset for the cross-file paragraph question and answer knowledge; the third element sum is an element sum of a third average similarity vector of the candidate node subset for the single-file structural question and answer knowledge; the third average similarity vector is an average value of similarity vectors of all nodes in the candidate node subset for the single-file structural question and answer knowledge; the fourth element sum is an element sum of a fourth average similarity vector of the candidate node subset for the single-file paragraph question and answer knowledge; and the fourth average similarity vector is an average value of similarity vectors of all nodes in the candidate node subset for the single-file paragraph question and answer knowledge; and
determining, based on the optimally-matched node set, file knowledge content corresponding to the user question, wherein the file knowledge content comprises the main title, the chapter title, the chapter abstract, a paragraph body of the file or combinations thereof.

2. The cross-file question and answer knowledge extraction method according to claim 1, further comprising: constructing the file embedding vector tree.

3. The cross-file question and answer knowledge extraction method according to claim 2, wherein the constructing the file embedding vector tree specifically comprises:
obtaining a plurality of professional knowledge files;
preprocessing the professional knowledge files to determine file information, wherein the file information comprises the main title, the chapter title, a paragraph body under each chapter, the chapter abstract, and the file abstract; and
constructing the file embedding vector tree based on the file information.

4. The cross-file question and answer knowledge extraction method according to claim 3, wherein the preprocessing the professional knowledge files to determine file information specifically comprises:
extracting key information of each of the professional knowledge files, wherein the key information comprises the main title, the chapter title, and the paragraph body under each chapter;
generating the chapter abstract for each chapter of each of the professional knowledge files by using an abstract generation function, wherein the abstract generation function is a deep learning-based abstract generation model or a rule-based abstract generation algorithm; and
generating the file abstract for each of the professional knowledge files based on a plurality of chapter abstracts of the professional knowledge file.

5. The cross-file question and answer knowledge extraction method according to claim 1, wherein the determining the user question embedding vector and a first similarity vector of a root node of a file embedding vector tree of each professional knowledge file specifically comprises:
calculating the inner product of the user question embedding vector and each of the main title embedding vector, the average embedding vector, and the abstract embedding vector of the file embedding vector tree of each professional knowledge file to obtain a first inner product, a second inner product, and a third inner product;
comparing the first inner product, the second inner product, and the third inner product to determine the maximum inner product value and the vector corresponding to the maximum inner product value; and
determining a first similarity vector for each root node based on the vector corresponding to the maximum inner product value and the user question embedding vector.

6. The cross-file question and answer knowledge extraction method according to claim 1, wherein the determining a plurality of similar vector trees by using a K-nearest neighbor algorithm based on first similarity vectors of all root nodes specifically comprises:
calculating a first similarity element sum of each root node, wherein the first similarity element sum is an element sum of the first similarity vector of the root node;
sorting all first similarity element sums in descending order, and selecting a first preset quantity of top first similarity element sums;
determining an initial candidate node set by using root nodes corresponding to the first preset quantity of top first similarity element sums as candidate nodes; and
selecting a benchmark similarity vector from the initial candidate node set, and determining a second preset quantity of similar vector trees by using the K-nearest neighbor algorithm, wherein the benchmark similarity vector is a first similarity vector corresponding to a maximum first similarity element sum, and the second preset quantity is less than the first preset quantity.

7. The cross-file question and answer knowledge extraction method according to claim 1, wherein the determining a candidate node set by using the K-nearest neighbor algorithm based on all the similar vector trees specifically comprises:
constructing a virtual root node based on a second preset quantity of similar vector trees;
calculating a second similarity vector between the user question embedding vector and a non-root and non-leaf node of each file embedding vector tree;
calculating a second similarity element sum of each non-root and non-leaf node, wherein the second similarity element sum is an element sum of a second similarity vector of the non-root and non-leaf node;
sorting all second similarity element sums in descending order, and selecting a third preset quantity of top second similarity element sums;
determining the candidate node subset for the cross-file structural question and answer knowledge by using the K-nearest neighbor algorithm based on the third preset quantity of top second similarity element sums;
calculating a third similarity vector between the user question embedding vector and a leaf node of each file embedding vector tree;
calculating a third similarity element sum of each leaf node, wherein the third similarity element sum is an element sum of a third similarity vector of the leaf node;
sorting all third similarity element sums in descending order, and selecting a fourth preset quantity of top third similarity element sums;
determining the candidate node subset for the cross-file paragraph question and answer knowledge by using the K-nearest neighbor algorithm based on the fourth preset quantity of top third similarity element sums;
determining all second similarity element sums in a first target file embedding vector tree, wherein the first target file embedding vector tree is a file embedding vector tree of a non-root and non-leaf node corresponding to a maximum second similarity element sum;
sorting all the second similarity element sums in the first target file embedding vector tree in descending order, and selecting a fifth preset quantity of top second similarity element sums in the first target file embedding vector tree;
determining the candidate node subset for the single-file structural question and answer knowledge based on the fifth preset quantity of top second similarity element sums;
determining all third similarity element sums in a second target file embedding vector tree, wherein the second target file embedding vector tree is a file embedding vector tree of a leaf node corresponding to a maximum third similarity element sum;
sorting all the third similarity element sums in the second target file embedding vector tree in descending order, and selecting a sixth preset quantity of top third similarity element sums in the second target file embedding vector tree; and
determining the candidate node subset for the single-file paragraph question and answer knowledge based on the sixth preset quantity of top third similarity element sums.

8. A cross-file question and answer knowledge extraction system, comprising:
a question obtaining module configured to obtain a user question;
a conversion module configured to convert the user question into a user question embedding vector by using an embedding function;
a similarity vector determining module configured to determine the user question embedding vector and a first similarity vector of a root node of a file embedding vector tree of each professional knowledge file, wherein the file embedding vector tree comprises the root node, a leaf node, and a non-root and non-leaf node; the root node comprises a main title of the file, a main title embedding vector, an average embedding vector of chapter title embedding vectors, a file abstract, and an abstract embedding vector; the first similarity vector is a product of a vector corresponding to a maximum inner product value of each root node and the user question embedding vector; the maximum inner product value is a maximum value among an inner product of the user question embedding vector and each of the main title embedding vector, the average embedding vector, and the abstract embedding vector; the vector corresponding to the maximum inner product value is the main title embedding vector, the average embedding vector, or the abstract embedding vector; the leaf node comprises paragraph text and a paragraph text embedding vector; the non-root and non-leaf node comprises a chapter title, a chapter title embedding vector, an average embedding vector of subtitle or paragraph embedding vectors, a chapter abstract, and a chapter abstract embedding vector;
a similar vector tree determining module configured to determine a plurality of similar vector trees by using a K-nearest neighbor algorithm based on first similarity vectors of all root nodes;
a candidate node determining module configured to determine a candidate node set by using the K-nearest neighbor algorithm based on all the similar vector trees, wherein the candidate node set comprises a candidate node subset for cross-file structural knowledge, a candidate node subset for cross-file paragraph knowledge, a candidate node subset for single-file structural knowledge, and a candidate node subset for single-file paragraph knowledge;
an optimally-matched node determining module configured to determine an optimally-matched node set based on the candidate node set, wherein the optimally-matched node set is a subset corresponding to a maximum element sum in the candidate node set; the maximum element sum is a maximum value of a first element sum, a second element sum, a third element sum, and a fourth element sum; the first element sum is an element sum of a first average similarity vector of the candidate node subset for the cross-file structural question and answer knowledge; the first average similarity vector is an average value of similarity vectors of all nodes in the candidate node subset for the cross-file structural question and answer knowledge; the second element sum is an element sum of a second average similarity vector of the candidate node subset for the cross-file paragraph question and answer knowledge; the second average similarity vector is an average value of similarity vectors of all nodes in the candidate node subset for the cross-file paragraph question and answer knowledge; the third element sum is an element sum of a third average similarity vector of the candidate node subset for the single-file structural question and answer knowledge; the third average similarity vector is an average value of similarity vectors of all nodes in the candidate node subset for the single-file structural question and answer knowledge; the fourth element sum is an element sum of a fourth average similarity vector of the candidate node subset for the single-file paragraph question and answer knowledge; and the fourth average similarity vector is an average value of similarity vectors of all nodes in the candidate node subset for the single-file paragraph question and answer knowledge; and
a knowledge extraction module configured to determine, based on the optimally-matched node set, file knowledge content corresponding to the user question, wherein the file knowledge content comprises the main title, the chapter title, the chapter abstract, a paragraph body of the file or combinations thereof.

9. An electronic device, comprising a memory and a processor, wherein the memory is configured to store a computer program, and the processor runs the computer program to enable the electronic device to execute the cross-file question and answer knowledge extraction method according to claim 1.

10. An electronic device, comprising a memory and a processor, wherein the memory is configured to store a computer program, and the processor runs the computer program to enable the electronic device to execute the cross-file question and answer knowledge extraction method according to claim 2.

11. An electronic device, comprising a memory and a processor, wherein the memory is configured to store a computer program, and the processor runs the computer program to enable the electronic device to execute the cross-file question and answer knowledge extraction method according to claim 3.

12. An electronic device, comprising a memory and a processor, wherein the memory is configured to store a computer program, and the processor runs the computer program to enable the electronic device to execute the cross-file question and answer knowledge extraction method according to claim 4.

13. An electronic device, comprising a memory and a processor, wherein the memory is configured to store a computer program, and the processor runs the computer program to enable the electronic device to execute the cross-file question and answer knowledge extraction method according to claim 5.

14. An electronic device, comprising a memory and a processor, wherein the memory is configured to store a computer program, and the processor runs the computer program to enable the electronic device to execute the cross-file question and answer knowledge extraction method according to claim 6.

15. An electronic device, comprising a memory and a processor, wherein the memory is configured to store a computer program, and the processor runs the computer program to enable the electronic device to execute the cross-file question and answer knowledge extraction method according to claim 7.

16. The electronic device according to claim 9, wherein the memory is a readable storage medium.

17. The electronic device according to claim 10, wherein the memory is a readable storage medium.

18. The electronic device according to claim 11, wherein the memory is a readable storage medium.

19. The electronic device according to claim 12, wherein the memory is a readable storage medium.

20. The electronic device according to claim 13, wherein the memory is a readable storage medium.
